(19) United States
(12) Patent Application Publication
(10) Pub. No.: US 2024/0373343 A1
(43) Pub. Date: Nov. 7, 2024

(54) METHOD FOR OPERATING A BATTERY-POWERED WIRELESS NODE AND A WIRELESS NODE

(71) Applicant: Diehl Metering Systems GmbH, Nürnberg (DE)

(72) Inventors: Petra Joppich-Dohlus, Rathsberg (DE); Achim Schmidt, Weissenohe (DE); Dominik Elberskirch, Nürnberg (DE); Johannes Wechsler, Spalt (DE)

(21) Appl. No.: 18/635,110

(22) Filed: Apr. 15, 2024

(30) Foreign Application Priority Data
May 4, 2023 (DE) 10 2023 111 684.3

(51) Int. Cl. H04W 52/02

(52) U.S. Cl. CPC H04W 52/0206

(57) ABSTRACT

A method operates a battery-powered wireless node, wherein the wireless node supports a low power wide area network (LPWAN) network protocol. The wireless node starts at least one joining process in order to set up a connection to the LPWAN. The wireless node sends a joining request for the joining process, and the wireless node opens at least one receive window after sending a joining request. A joining request is allocated an energy consumption. The energy consumption allocated to the joining request is incorporated in an energy budget. The sending or not-sending of a joining request is controlled according to the energy budget.

### CROSS-REFERENCE TO RELATED APPLICATION

This application claims the priority, under 35 U.S.C. § 119, of German Patent Application DE 10 2023 111 684.3, filed May 4, 2023; the prior application is herewith incorporated by reference in its entirety.

### FIELD AND BACKGROUND OF THE INVENTION

The present invention relates to a method for operating a battery-powered wireless node, wherein the wireless node supports a low power wide area network (LPWAN) network protocol, the wireless node starts at least one joining process in order to set up a connection to a LPWAN, the wireless node sends a joining request for the joining process, and the wireless node opens at least one receive window after sending the joining request. The invention further relates to a wireless node having an antenna, a control unit, a battery and a sensor device and/or an actuator device.

The invention relates to a method for operating a battery-powered wireless node that supports a low power wide area network (LPWAN) network protocol, for example the long range wide area network (LoRaWAN) network protocol, for instance as described in the LoRaWAN L2 1.0.4 specification (TS001-1.0.4), or supports the MIOTY network protocol, for instance as described in ETSI TS 103 357 V1.1.1 (2018 June). This means that the wireless node can connect to a LPWAN. This is a wireless network that uses unlicensed frequency bands. A large number of wireless nodes are provided in such a network, each communicating by radio with at least one gateway by means of bidirectional data transmission. The gateway forwards the data received from the wireless node to a LPWAN server. In the bidirectional data transmission, datagrams are sent in the uplink from the wireless node to the LPWAN server via the gateway, and are sent in the downlink from the LPWAN server to the wireless node via the gateway. In addition, in the LPWAN is provided an application server, which receives and processes the wireless-node data from the LPWAN server.

A wireless node can be a sensor device for capturing data of any type, an actuator device for performing certain actions or measures, or a combination of a sensor device and an actuator device. Such wireless nodes are powered by their own, i.e. self-sufficient, energy supply, preferably an energy supply that is self-sufficient over the long term, in the form of a battery, for example a long-life battery, which has a limited operating life depending on the specific energy consumption of the wireless node, and which is not rechargeable but which must be replaced at the end of the operating life. Normally, a service life “in the field” of several years, in particular at least ten years, can be achieved with such a battery until it needs replacing.

In order to communicate within the LPWAN, the wireless node must join this LPWAN by means of a joining process. A joining process contains a joining request and a joining acceptance. In this process, the wireless node transfers the joining request to a joining server of the LPWAN in order to start the joining process. Following the sending of the joining request, the wireless node opens at least one receive window in order to receive the joining acceptance. The joining server transfers the joining acceptance to the wireless node in response to the joining request from the wireless node, if this wireless node is allowed to join the LPWAN. The joining acceptance is received by the wireless node within the at least one receive window. The wireless node can communicate via the LPWAN once it has received the joining acceptance.

The joining process can be performed in different situations. For example, the joining process can be performed when the wireless node is first started up, so that the wireless node can join a LPWAN for the first time. A joining process can also be performed if the wireless node has not received any further downlink transmissions from the LPWAN server over a certain period of time. In addition, a joining process can be performed if the wireless node is reconfigured or newly configured, for instance when it is removed from one LPWAN and is meant to join another LPWAN.

In some situations, although the wireless node starts a joining process by sending the joining request, the joining process is not successfully completed because the wireless node does not receive a joining acceptance from the joining server. In such situations, the wireless node continues to attempt to join the LPWAN, and repeatedly sends a joining request. The wireless node consumes energy as a result of the continuous sending of joining requests.

### SUMMARY OF THE INVENTION

The object of the present invention is to provide a method for operating a battery-powered wireless node, which method can be used to reduce the energy consumption of the wireless node.

### Achieving the Object

The above object is achieved by a method having the features of the independent method claim and by a wireless node according to the independent wireless node claim. The associated dependent claims contain expedient embodiments of the method according to the invention and of the wireless node.

According to the invention, a method for operating a battery-powered wireless node is provided, wherein the wireless node supports a Low Power Wide Area Network (LPWAN) network protocol, in particular the Long Range Wide Area Network (LoRaWAN) network protocol or the MIOTY network protocol, wherein the wireless node starts at least one joining process, in particular a join process, in order to set up a connection to a LPWAN. For the joining process, the wireless node sends a joining request, in particular a join request to a join server or an attach request to a service center, of the LPWAN in order to start the joining process. The wireless node opens at least one receive window after sending the joining request in particular in order to receive a joining acceptance from the joining server, in particular a join accept from the join sever or an attach accept from the service center, of the LPWAN. The joining request, preferably the sending of the joining request, is allocated an, in particular predetermined, energy consumption. The energy consumption allocated to the joining request is included in an energy budget, in particular of the wireless node. The sending or not-sending of a joining request is controlled according to the, in particular present, energy budget.

The wireless node supporting the LPWAN network protocol means that the wireless node is capable of connecting to a LPWAN and communicating within this LPWAN with further network users or network devices. The allocated energy consumption is, for example, a certain amount of electrical energy or electrical power, which depends in particular on the data rate or the spreading factor of the joining request. Based on the energy budget, the wireless node can control according to the invention whether or not a joining request shall be sent. Expediently, when the energy budget reaches or drops below a predetermined level or value, the sending of a joining request is stopped or paused, and/or further energy saving measures are implemented. A decision criterion here can be, for example, the present capacity of the battery and/or the recent energy consumption, for instance in the last hour(s) or the last day, and/or the number of joining processes already started and/or a predetermined time elapsing since the first start of a joining process. The wireless node can save energy by not sending a joining request. As a result, a sufficient “service life” of the wireless node of several years, in particular at least ten years, can be guaranteed.

The allocated energy consumption preferably depends on the transmission time length of the joining request. The wireless node can determine the energy consumption of the joining request on the basis of the transmission time length and the energy needed for the transmission per unit of time. The energy consumption can hence be determined extremely accurately.

Expediently, the allocated energy consumption additionally contains the energy consumption for opening the at least one receive window. For example, the allocated energy consumption can also comprise the energy consumption for receiving a joining acceptance. The energy consumption here reflects all the steps of a joining process.

In particular, the allocated energy consumption of the receive windows depends on the active time of the wireless node in the receive mode. The wireless node can determine the energy consumption required on the basis of the length of time that the wireless node is in the receive mode and the energy needed per unit of time for the active time or the receive mode. The energy consumption can hence be determined extremely accurately.

The allocated energy consumption can advantageously be determined empirically or estimated. In particular, the allocated energy consumption is the arithmetic mean of the energy required to send a joining request and/or to open the at least two receive windows and/or to receive a joining acceptance, which energy consumption is determined, preferably experimentally, under different installation situations and/or environmental conditions, for instance different temperatures and/or different air humidity levels. Alternatively, the allocated energy consumption can also be estimated with reference to a geographical installation situation of the wireless node, for instance in warm regions or in cold regions.

The energy budget is expediently conducted as a credit point system containing a credit point score. The credit point score represents a number of credit points and reflects the electrical energy or electrical power available to the wireless node at that instant. In this context, a credit point, or the credit point score, equates to, for instance, a certain amount of electrical energy or electrical power. The available energy can be the basis for influencing the sending or not-sending of a joining request and for limiting the electricity consumption or energy consumption by the wireless node in an effective manner. Hence, for instance, it is possible not to send a joining request when there is a low credit point score. Expediently, the credit point score reflects solely the energy budget for the joining request or the joining process. Alternatively, the credit point score can represent the entire energy budget of the wireless node, for example the entire energy budget for radio communication.

Advantageously, the energy consumption allocated to the sending of the joining request and/or to the opening of the at least one receive window and/or to the receiving of the joining acceptance is associated with a predetermined number of credit points. In particular, the number of credit points equates to the energy required for a joining request and the opening of the at least one receive window.

Expediently, because of a joining request being sent, the, preferably current, credit point score of the wireless node is reduced by the predetermined number of credit points, for instance by decrementing or subtraction. The energy consumed by the wireless node is thereby also taken into account in the credit point score. In particular, the credit point score is reduced before the sending of a joining request, i.e. before the start of the joining process, by the number of credit points predetermined therefor.

Expediently, in particular during operation of the wireless node using the credit point system, the credit point score of the wireless node is increased, preferably progressively, for each elapsed unit of time by a predetermined number of credit points, for instance by incrementing or addition. The unit of time is, for example, seconds, minutes, hours or days. The energy currently available to the wireless node for a joining process is thereby increased per unit of time. In particular, the device is provided over the entire operating life with a certain energy budget, which is not exceeded by the progressive increase in the credit points.

By no joining request being sent if the credit point score of the wireless node reaches or drops below a limit value, the wireless node does not send out any radio signals, thereby allowing energy to be saved.

Expediently, a further joining request is sent if the wireless node does not receive a joining acceptance from the joining server within the at least one receive window. Hence the wireless node starts further attempts to connect to the LPWAN, and an attempt to set up a connection to the LPWAN is made repeatedly, in particular successively. In particular, no further joining processes are started on successful completion of the joining process, i.e. the wireless node receiving the joining acceptance. The sending of joining requests preferably stops once the credit point score of the energy budget drops below or reaches a certain level or a value.

Expediently, a plurality of joining requests are sent bundled in the form of a burst according to the energy budget. In a burst, a plurality of joining requests are sent at short time intervals one after the other. Thus, this involves a clustering of joining requests within a short time. A burst preferably contains five bundled joining requests.

The sending of a plurality of bursts means that joining processes are started successively, and therefore multiple, in particular successive, attempts are made to set up a connection to the LPWAN. The bursts are preferably mutually spaced in time so that the wireless node does not send a joining request between the bursts. Thus, the bursts are sent at an interval or periodically. For example, the timespan between two successive joining requests lengthens as the number of bursts increases. As a result, the interval at which the bursts are sent gets longer. An increase in the time length, or the lengthening of the interval, between two bursts is a simple way of saving energy, since the wireless node sends joining requests less frequently. Expediently, the wireless node is in an idle mode or sleep mode between two bursts, in which in particular only the radio activity of the wireless node is in shutdown or is switched-off, whereas other activities such as sensor activities and/or actuator activities are still guaranteed. This further reduces the energy consumption of the wireless node.

Pausing the sending of joining requests, according to the energy budget, after a predetermined number of sent joining requests or of sent joining requests per unit of time, or after a predetermined time has elapsed results in no further joining request being sent after the predetermined number of unsuccessful joining processes or joining processes per unit of time, or after the time has elapsed, thereby saving energy. The sending of the joining requests is thereby paused for a predetermined time, and resumed after the time has elapsed. The elapsed time preferably relates to a certain timespan from the sending of a joining request, in particular for the first time, during the connection setup currently in progress. Expediently, during suspension of the joining processes, the wireless node shifts into idle mode or sleep mode, in which only the radio communication of the wireless node is in shutdown. The wireless node can thereby save energy in a simple way.

Expediently, the wireless node does not send any joining requests in a predetermined time period. During this time period, the wireless node preferably shifts into idle mode or sleep mode.

The wireless node preferably supports a second network protocol, so that the wireless node can communicate by means of a further network protocol in addition to the LPWAN network protocol as the first network protocol, and can be integrated into a further network. The wireless node thereby has a plurality of communication options available. Expediently, either the first network protocol or the second network protocol is active. Thus the wireless node can communicate only by means of one network protocol at any given time. This is a simple way of complying with the duty cycle and/or avoiding interference.

The second network protocol is preferably M-Bus, for instance as specified in DIN EN 13757, preferably in DIN EN 13757-4:2019-09. This is preferably the C mode “Compact Mode” M-Bus, as specified in DIN EN 13757, preferably in DIN EN 13757-4:2019-09.

Expediently, the at least one receive window is opened at a certain time interval after the end of the sending of the joining request, thereby providing the joining server, in particular the join server or service center, with enough time to send a joining acceptance in response to the joining request. For example, the time interval for a first receive window equals between 1 s and 15 s from the end of the sending of the joining request.

In particular, a first and a second receive window are provided, with the second receive window being opened if a joining acceptance is not received in the first receive window. This creates additional energy-saving potential as the second receive window is opened only if a joining acceptance is not received within the first receive window. If a joining acceptance is received in the first receive window, the second receive window is accordingly not opened. Expediently, the second receive window is opened between 2 s and 16 s after the end of the sending of the joining request. In particular, the first receive window and the second receive window are not open at the same time but offset from each other in time.

Advantageously, the second receive window is opened spaced apart in time from the first receive window.

Expediently, the wireless node goes into idle mode or sleep mode after sending the joining request and/or after closing a receive window and/or after receiving the joining acceptance and/or after a burst.

The sending or not-sending of the joining request is expediently controlled by a control unit of the wireless node. The wireless node can thereby control the method, in particular autonomously. The method can hence be controlled independently of a gateway and/or a LPWAN server and/or the joining server and/or an application server.

Expediently, the Low Power Wide Area Network (LPWAN) network protocol is the Long Range Wide Area Network (LoRaWAN) network protocol, for instance as described in the LoRaWAN L2 1.0.4 specification (TS001-1.0.4), or is the MIOTY network protocol, for instance as described in ETSI TS 103 357 V1.1.1 (2018 June).

The present invention also relates to a wireless node. According to the invention, the wireless node contains an antenna, a control unit, a battery and a sensor device and/or an actuator device, which wireless node is designed to perform the method.

Expediently, the wireless node is a sensor device, in particular a consumption meter for measuring electricity consumption or gas consumption or water consumption. Alternatively, the wireless node can be an actuator device for performing certain actions or measures, or a combination of a sensor device and an actuator device.

The wireless node can expediently be operated in the unlicensed ISM bands or SRD bands, preferably in a frequency band in the range of 865.0-868.0 MHz or 868.0-868.6 MHz or 869.4-869.65 MHz or 902-928 MHz.

Other features which are considered as characteristic for the invention are set forth in the appended claims.

Although the invention is illustrated and described herein as embodied in a method for operating a battery-powered wireless node and a wireless node, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of a long-range wide area network (LoRaWAN);

FIG. 2 is a block diagram of an example wireless node;

FIGS. 3A-E are highly simplified representations of a procedure of a joining process;

FIG. 4 is a graph showing an example of a variation over time of a credit point score of the wireless node shown in FIG. 2; and

FIG. 5 is an illustration showing by way of example of a plurality of joining requests grouped into a burst.

### DETAILED DESCRIPTION OF THE INVENTION

The figures show expedient embodiments of the invention based on a Long Range Wide Area Network (LoRaWAN). The method according to the invention can also be used, however, for other Low Power Wide Area Network (LPWAN) network protocols such as the MIOTY network protocol, for example.

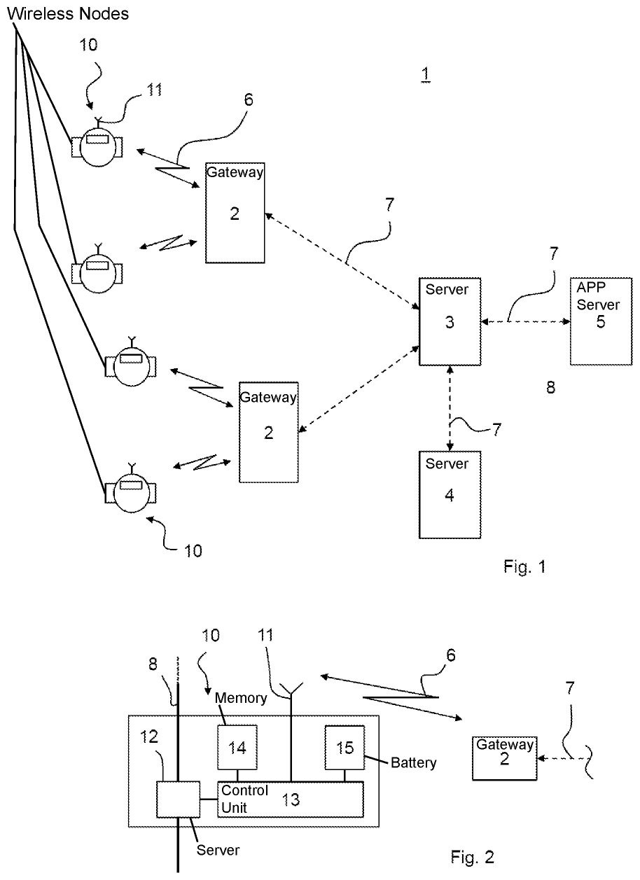

Referring now to the figures of the drawings in detail and first, particularly to FIG. 1 thereof, there is shown a highly simplified schematic representation of a long range wide area network (LoRaWAN) 1. The LoRaWAN 1 shown contains a plurality of wireless nodes 10 having an antenna 11, and comprises two gateways 2, a network server 3, an application server 5 and a joining server 4, in particular a join server. The wireless node 10 supports the Long Range Wide Area Network (LoRaWAN) network protocol. This means that the wireless node 10 is technically designed to communicate within a LoRaWAN 1 with further users of the LoRaWAN 1 via the LoRaWAN.

The wireless nodes 10 communicate with the gateways 2 by means of radio-based data transmission 6. Here, the top two wireless nodes 10 communicate with the top gateway 2, and the bottom two wireless nodes 10 communicate with the bottom gateway 2. The gateways 2 communicate with the network server 3 by means of radio-based or cable-based data transmission 7. Alternatively, just one gateway 2 or more than two gateways 2 can be provided in the LoRaWAN 1.

Bidirectional data transmission takes place between an individual wireless node 10 and the LoRaWAN server 3 via the gateway 2, which is in communication with the individual wireless node 10. In this process, data in the form of a datagram or a part of a datagram or a command or a part of a command is transmitted in an uplink transmission from the wireless node 10 to the gateway 2 by means of the radio-based data transmission 6, and forwarded from there to the network server 3 by means of the radio-based or cable-based data transmission 7. The data in the uplink transmission is transmitted in particular from the network server 3 to the application server 5.

In a downlink transmission, data in the form of a datagram or a part of a datagram or a command or a part of a command is transmitted from the network server 3 to the gateway 2 by means of the data transmission 7, and forwarded from there to the wireless node 10 by means of the data transmission 6.

For example, the data transmission in the uplink transmission and/or the downlink transmission between the wireless node 10 and network server 3 can also take place via a plurality of gateways 2 (not shown in the figures).

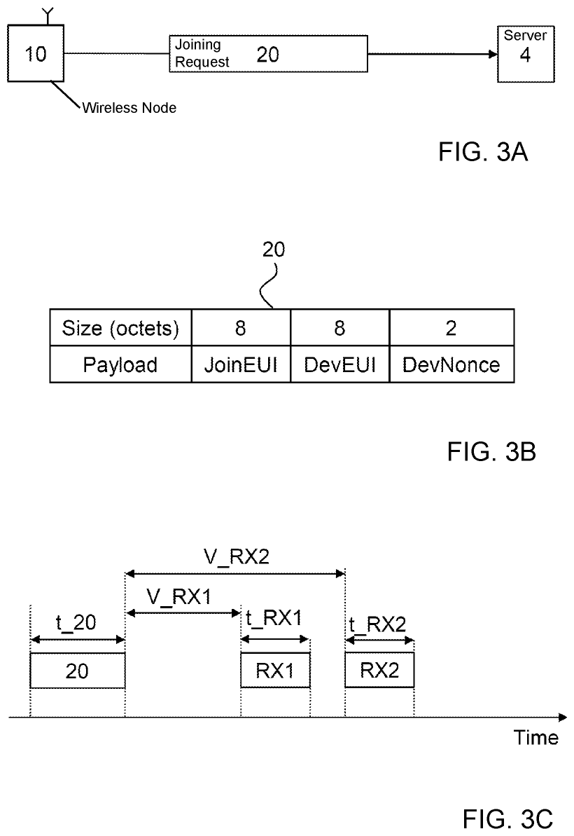

The wireless node 10 is supplied with energy via a battery 15 (see FIG. 2). The battery 15 can be a long-life battery, which does not need replacing until the end of the operating life. Normally, such a long-life battery can guarantee an energy supply that is self-sufficient over a long period of several years. The wireless node 10 thereby achieves, for example, a service life “in the field” of at least ten years. Expediently, the battery 15 is fixedly installed in the wireless node 10, so that the entire wireless node 10 must be replaced at the end of the operating life of the battery 15.

The wireless node 10 also comprises a control unit 13 and a memory 14. The wireless node 10 shown in FIG. 2 is a sensor device for capturing data of any type. The wireless node 10 contains for this purpose a sensor 12, mounted on a supply line 8, for instance for capturing an electricity consumption or a flow rate of a liquid or gas. Alternatively, the wireless node 10 can also be an actuator device for performing certain actions or measures, or a combination of a sensor device and an actuator device.

The readings measured by the sensor 12 are transmitted to the control unit 13. For example, the control unit 13 processes the readings and then saves these in the memory 14. Alternatively, the readings can be saved in the memory 14 directly, i.e. without any processing by the control unit 13. The control unit 13 can access the, for instance processed, readings stored in the memory 14, and send these via the antenna 11 to the application server 5 via the gateway 2 and the network server 3 by means of an uplink transmission. The application server 5 processes, manages and/or interprets the data originating from the wireless nodes 10. For example, this allows the consumption measured by the sensor 12 to be analyzed and, in particular, billed to an end customer.

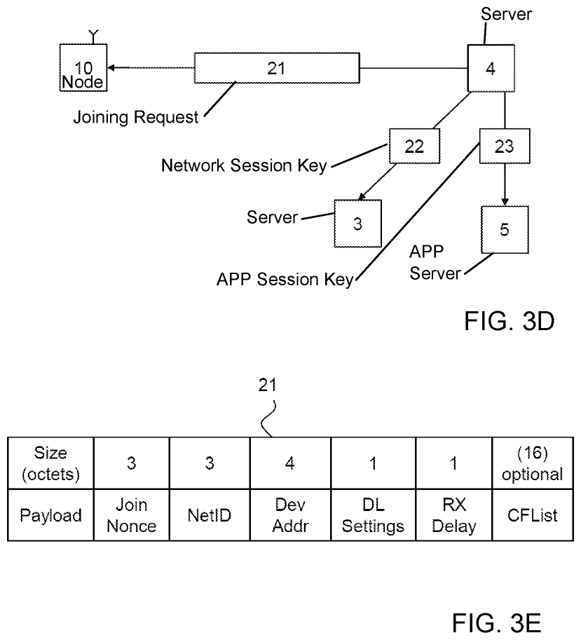

The wireless node 10 must join a LoRaWAN 1 in order to be able to communicate within the LoRaWAN 1. This is done by performing a joining process, also known as a join process. The joining process is started by the wireless node 10 and contains a joining request 20, also known as a join request (see FIGS. 3A and 3b), which is sent by the wireless node 10. The joining process also comprises a joining acceptance 21, also known as a join accept (see FIGS. 3D and 3E), which is received by the wireless node 10. The joining process is represented schematically in FIGS. 3A-3E, and is described below.

A joining process is usually performed when a wireless node 10 is commissioned. The wireless node 10 also starts the joining process if the wireless node 10 no longer has a connection to the network server 3. This is identified by the wireless node 10 if, for instance, it has not received a downlink transmission from the network server 3 over a prolonged period of time despite a reduction in the data rate and associated increase in the range. In addition, a joining process can also be performed when the wireless node 10 is newly configured or reconfigured. In this case, the wireless node 10 is assigned a new LoRaWAN 1, which the wireless node 10 must join.

To perform a joining process, a DevEUI (wireless node identifier) is meant to be present in the wireless node 10. The DevEUI is a global wireless-node identification number that uniquely identifies the wireless node 10. In addition, the wireless node 10 is meant to have a JoinEUI (joining server identifier), which is a global application identification number and uniquely identifies the joining server 4 of the LoRaWAN 1 globally. An AppKey (application key) is also meant to be present in the wireless node 10. The AppKey is assigned specifically to this wireless node 10, and is used to process a received joining acceptance 21, as described below.

The wireless node 10 starts or initiates the joining process by sending the joining request 20 to the joining server 4 (see FIG. 3A). The joining request 20 (see FIG. 3b) contains in its payload or wanted data the JoinEUI, the DevEUI and a DevNonce. The JoinEUI and the DevEUI each have a size of 8 octets or bytes; the DevNonce has a size of 2 octets. The DevNonce is a counter that is incremented with every sent joining request 20. The joining request 20 is transmitted from the wireless node 10 to the joining server 4. The transmission of the joining request 20 takes a certain time t_20. Expediently, after the sending of the joining request 20, the wireless node 10 shifts into an idle mode 25 or sleep mode, in which in particular only the radio activity of the wireless node is in shutdown or is switched-off, whereas other activities such as sensor activities and/or actuator activities are still guaranteed. This further reduces the energy consumption of the wireless node.

Following the sending of the joining request 20, the wireless node 10 opens a first receive window RX1 in order to receive a joining acceptance 21 (see FIG. 3C). The first receive window RX1 is opened a certain time interval V_RX1 after the sending of the joining request 20 ends. The time interval V_RX1 is calculated from the end of the sending of the joining request 20, and, for example, is a time value between 1 s and 15 s. The first receive window RX1 is open for a certain time length t_RX1, which the wireless node 10 needs to receive the joining acceptance 21. The first receive window RX1 is closed again once the time length t_RX1 has elapsed. The wireless node 10 expediently shifts into idle mode after the first receive window RX1 is closed.

In the event that the wireless node 10 has not received a joining acceptance 21 during the first receive window RX1, the wireless node 10 opens a second receive window RX2, which is opened at a certain time interval V_RX2, for instance a time value between 2 s and 16 s, after the sending of the joining request 20 ends. Thus, the second receive window RX2 is opened after the first receive window RX1, in particular spaced therefrom in time. The second receive window RX2 is likewise open for a certain time length t_RX2, which the wireless node 10 needs to receive the joining acceptance 21. The second receive window RX2 is closed again after the timespan t_RX2 has elapsed. The wireless node 10 expediently shifts into idle mode after the second receive window RX2 is closed.

The joining request 20 from the wireless node 10 is received by the joining server 4. The joining server 4 thereupon checks whether the wireless node 10 is allowed to join the LoRaWAN 1. If the wireless node 10 is allowed to join the LoRaWAN 1, the joining server 4 sends the joining acceptance 21 in response to the joining request 20 by the wireless node 10, as shown in FIG. 3D. The joining acceptance 21 contains in its payload or wanted data various information, as shown in FIG. 3E. The joining acceptance 21 contains a JoinNonce, which is a non-repeating value that is provided by the joining server 4. In addition, the joining acceptance 21 contains a NetID (network identifier), a DevAddr (wireless node address), DLSettings (downlink configuration settings), a RXDelay (delay between an uplink transmission and receiving a downlink) and optionally a CFList (list of network parameters).

The joining acceptance 21 is received by the wireless node 10 within the first receive window RX1 or the second receive window RX2. The wireless node 10 uses the AppKey, which it knows, to derive from the JoinNonce of the joining acceptance 21 the network session key (NwkSKey) 22 and the application session key (AppSKey) 23. The network session key 22 and the application session key 23 are likewise also generated by the joining server 4. The joining server 4 transmits the network session key 22 to the network server 3, and the application session key 23 to the application server 5, (see FIG. 3D). The network session key 22 is used within the LoRaWAN 1 by the network server 3 and the wireless node 10 to ensure data integrity. The application session key 23 is used by the application server 5 and the wireless node 10 to encrypt and decrypt transmitted data.

The network session key 22 is therefore known to the network server 3 and to the wireless node 10 after completion of the joining process. The application session key 23 is known to the application server 5 and to the wireless node 10. As a result, the wireless node 10 and the network server 3 and respectively the application server 5 can communicate with each other. The joining process has hence been completed successfully.

It can happen in some situations that although the wireless node 10 starts the joining process, this process is not successfully completed. In such situations, the wireless node 10 does not receive a joining acceptance 21 in response to a sent joining request 20. Such a situation can exist, for example, if the joining server 4 declines a joining request 20 by the wireless node 10. Alternatively, it can happen that the joining server 4 does not even receive the joining request 20 because the joining server is outside the range of the wireless node 10 or is switched-off.

In such situations, the wireless node 10 starts further joining processes. Thus, it repeatedly sends a joining request 20 and subsequently opens the receive windows RX1 and RX2. The wireless node 10 consumes a large amount of energy in the process. This can flatten the battery 15 prematurely, with the result that the intended service life of several years is not achieved.

According to the invention, an energy consumption is allocated to the sending of a joining request 20 and/or to the opening of the at least one receive window RX1 and RX2 and/or to the receiving of the joining acceptance 21. The allocated energy consumption depends here on the transmission time length of the join request 20 and/or the active time of the wireless node in the receive mode.

This allocated energy consumption is incorporated in an energy budget of the wireless node 10. The sending or not-sending of a joining request 20 is controlled on the basis of the energy budget. A decision criterion here can be, for example, the present capacity of the battery 15 and/or the recent energy consumption, for instance in the last hour or the last day, and/or the number of joining requests 20 already sent, and/or a predetermined time elapsing since the sending of a joining request 20. The wireless node 10 can save energy by not sending a joining request 20.

The allocated energy consumption can be determined empirically or estimated. In particular, the allocated energy consumption is the arithmetic mean of the energy required to send the joining request 20 and/or to open the at least two receive windows RX1 and RX2 and/or to receive the joining acceptance 21, which energy consumption is determined, preferably experimentally, under different installation situations and/or environmental conditions, for instance different temperatures and/or different air humidity levels. Alternatively, the allocated energy consumption can be estimated with reference to a geographical installation situation of the wireless node, for instance in warm regions or in cold regions.

Expediently, the energy budget of the wireless node 10 is in the form of a credit point system. The credit point system contains a credit point score N, which reflects the electrical energy or electrical power currently available to the wireless node 10. Thus, the credit point score N states how much energy is available to the wireless node 10 at that instant, or how much energy the wireless node 10 can consume at that instant. The sending or not-sending of a joining request 20 is preferably controlled according to the credit point score N. The credit point system is expediently controlled by the control unit 13 of the wireless node 10.

The credit point score N contains a variable number of credit points. A credit point equates to a certain energy requirement. In particular, a credit point can be a certain amount of electrical energy or electrical power. Expediently, a credit point is a whole number.

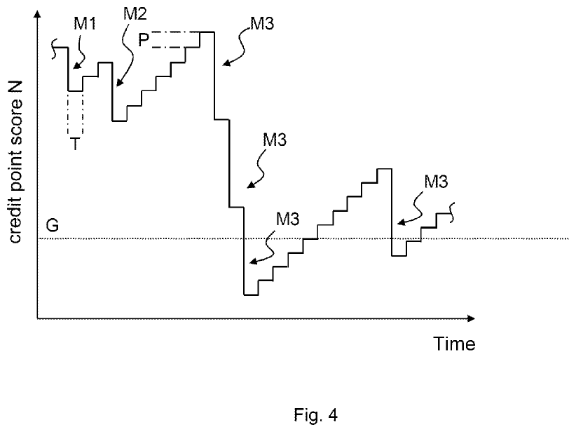

As shown in FIG. 4, the credit point score N changes progressively. The credit point score N is increased for each unit of time T by a predetermined number of credit points P. The predetermined number of credit points P is in particular greater than or equal to 1. In particular, the predetermined number of credit points P is added onto the current credit point score N. Hence the energy available to the wireless node 10 at that instant increases over time. The unit of time T is a certain number of seconds, minutes, hours or days.

As shown in FIG. 4, the credit point score N can represent the entire energy budget of the radio communication of the wireless node 10, for instance with all further communications being incorporated in the credit point system with their energy consumption. The credit point score N of the wireless node 10 is reduced by a predetermined number of credit points M1-M4 (see FIG. 4), for example, when an uplink transmission is sent and/or a downlink transmission is received. Each type of uplink transmission or downlink transmission is assigned a predetermined number of credit points M1, M2 according to the energy required for the transmission. For instance, only a small amount of energy is needed to send readings, and hence the credit point score N is reduced only by a few credit points M1. Certain uplink or downlink transmissions, for instance synchronizations and firmware updates, need more energy, however, and therefore for these uplink or downlink transmissions, the credit point score N is reduced by a larger number of credit points M2.

FIG. 4 shows by way of example the variation over time of the credit point score N. The credit point score N is initially reduced by a number of credit points M1 because of an uplink or downlink transmission. Then, the credit point score N rises again over two units of time T, with the credit point score N being increased by a certain number of credit points P per unit of time. The credit point score N is reduced again by a number of credit points M2 as a result of a further uplink or downlink transmission. Then the credit point score N rises again.

If, for example, the wireless meter 10 then loses radio contact with the LoRaWAN 1, the wireless meter 10 starts the joining process and sends a joining request 20. The joining request 20 and/or the opening of the at least one receive window is assigned a predetermined number of credit points M3 that reflects the allocated energy consumption. The credit point score N is reduced by the predetermined number of credit points M3 when a joining request is sent. If the wireless node 10 does not receive a joining acceptance 21, the joining request 20 is sent repeatedly, and the credit point score N is repeatedly reduced by the predetermined number of credit points M3 (see FIG. 4).

The credit point score N further contains a limit value G, which equals a certain number of credit points. No further joining requests 20 are sent once the credit point score N reaches or drops below the limit value G. As a result, the credit point score N rises again, until the limit value G is exceeded again and a new joining request 20 is sent. The sending of a joining request 20 is hence suspended while the credit point score N is below the limit value G. The wireless node 10 can thereby save energy in an effective manner.

Alternatively, the credit point score N of the wireless node 10 can represent the energy budget only for performing joining processes. In this case, further radio communications are not incorporated in the energy budget.

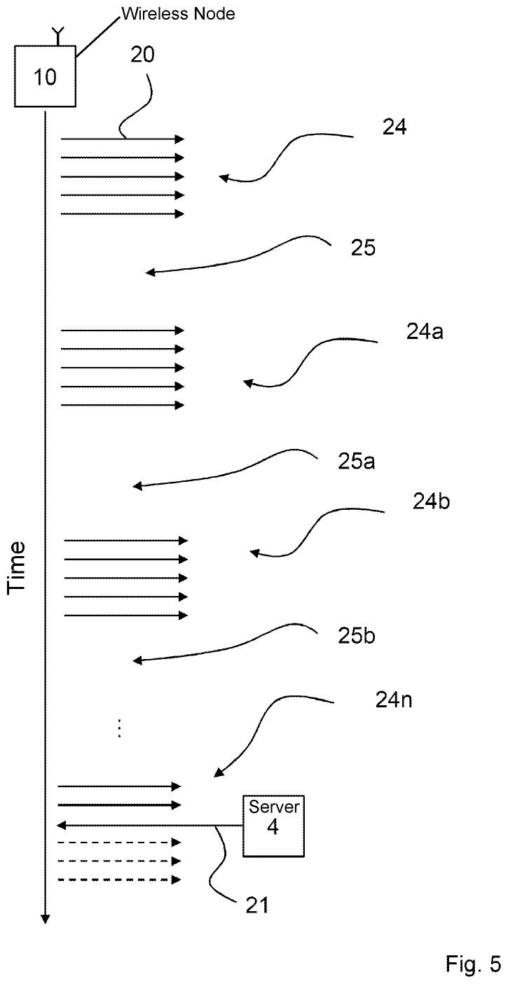

A plurality of sent joining requests 20 by a wireless node 10 can be grouped into a burst 24, as shown in FIG. 5. A burst 24 contains, for example, five sent joining requests 20. The individual joining requests 20 of the burst 24 are here mutually spaced in time, in particular such that the wireless node 10 has enough time to open the at least one receive window RX1 or RX2. The wireless node 10 is in an active mode while the burst 24 is being sent. After the sending of the burst 24, the sending of the joining requests 20 is suspended, and the wireless node 10 goes into an idle mode 25 and sends no further joining requests 20.

After a predetermined timespan, the idle mode 25 of the wireless node 10 comes to an end again, and the wireless node 10 once again sends a burst 24a. Thus the bursts 24 are sent at certain intervals. Then, if the wireless node 10 has not received a joining acceptance 21, it returns to idle mode 25.

The timespan of the idle mode 25, or the interval between sending the bursts, is extended each time. Hence the timespan of the idle mode 25a after the second burst 24a is longer than the timespan of the idle mode 25 after the first burst 24. The timespan of the third idle mode 25b is in turn longer than the timespan of the second idle mode 25a. Increasing the time length of the idle mode 25 is a simple way to save energy.

This procedure is repeated until the wireless node 10 receives a joining acceptance 21. This is shown by way of example for the burst 24n in FIG. 5. Here, the wireless node 10 receives during the burst 24n a joining acceptance 21 from the joining server 4 in response to the second sent joining request 20. The wireless node 10 has now joined the LoRaWAN 1, and the joining process is completed successfully. As a result, the remaining joining requests 20 of the burst 24n (shown dashed in FIG. 5) are no longer sent.

Alternatively or additionally, the burst 24 can be bounded by a time limit, after which the wireless node 10 sends no further joining requests 20. Expediently, the wireless node 10 does not send any joining requests 20 in a predetermined time period. This allows the wireless node 10 to communicate by means of a second network protocol, for example, in the time period in which no bursts 24 are being sent.

Advantageously, the wireless node 10 supports a second network protocol, with the LoRaWAN network protocol here being the first network protocol. Thus, the wireless node 10 can communicate by means of the second network protocol in addition to the LoRaWAN network protocol. Expediently, either the first network protocol or the second network protocol is active, and therefore communication is possible only by means of one network protocol at any given time. Thus, for example, the second network protocol is suspended during sending of the bursts 24.

For example, the second network protocol is the M-Bus network protocol, in particular the C-mode M-bus.

The following is a summary list of reference numerals and the corresponding structure used in the above description of the invention:

### LIST OF REFERENCES

1 LoRaWAN
2 gateway
3 network server
4 joining server
application server
6 data transmission
7 data transmission
8 supply line
wireless node
11 antenna
12 sensor
13 control unit
14 memory
battery
20 joining request
21 joining acceptance
22 network session key
23 application session key
24-24n burst
25-25n idle mode

1. A method of operating a battery-powered wireless node, wherein the battery-powered wireless node supports a low power wide area network (LPWAN) network protocol, which comprises the steps of:
starting, via the battery-powered wireless node, at least one joining process to set up a connection to the LPWAN;
sending, via the battery-powered wireless node, a joining request for the at least one joining process;
opening, via the battery-powered wireless node, at least one receive window after sending the joining request;
allocating the joining request an energy consumption, the energy consumption allocated to the joining request being incorporated in an energy budget; and
controlling a sending or not-sending of the joining request according to the energy budget.

2. The method according to claim 1, wherein an allocated energy consumption depends on a transmission time length of the joining request.

3. The method according to claim 2, wherein the allocated energy consumption additionally contains the opening of the at least one receive window.

4. The method according to claim 3, wherein the allocated energy consumption of receive windows depends on an active time of the battery-powered wireless node in a receive mode.

5. The method according to claim 2, which further comprises determining the allocated energy consumption empirically or estimated.

6. The method according to claim 1, which further comprises conducting the energy budget as a credit point system, wherein the credit point system has a credit point score.

7. The method according to claim 6, wherein the energy consumption allocated to the joining request is associated with a predetermined number of credit points.

8. The method according to claim 7, wherein the credit point score is reduced by an associated number of credit points because of the joining request being sent.

9. The method according to claim 6, which further comprises increasing the credit point score of the battery-powered wireless node for each elapsed unit of time by a predetermined number of credit points.

10. The method according to claim 6, wherein no said joining request is sent if the credit point score of the battery-powered wireless node reaches a limit value.

11. The method according to claim 1, which further comprises sending a plurality of joining requests bundled in a form of a burst according to the energy budget.

12. The method according to claim 11, wherein a plurality of bursts are sent in mutually spaced in time.

13. The method according to claim 11, which further comprises pausing the sending of joining requests after a predetermined number of sent joining requests or of sent joining requests per unit of time, or after a predetermined time has elapsed.

14. The method according to claim 1, wherein the battery-powered wireless node sends no joining requests in a predetermined time period.

15. The method according to claim 1, wherein the battery-powered wireless node goes into an idle mode:
after sending the joining request; and/or
after closing of the at least one receive window; and/or
after receiving a joining acceptance; and/or
after a burst.

16. The method according to claim 1, wherein the battery-powered wireless node supports a second network protocol, wherein the LPWAN network protocol is a first network protocol.

17. The method according to claim 16, wherein the second network protocol is an M-Bus.

18. The method according to claim 1, which further comprises opening the at least one receive window at a certain time interval after an end of the joining request.

19. The method according to claim 1, wherein the at least one receive window includes a first receive window and a second receive window, the second receive window is opened if no joining acceptance is received in the first receive window.

20. The method according to claim 19, which further comprises opening the second receive window after the first receive window.

21. The method according to claim 1, which further comprises controlling the sending and/or the not-sending of the joining request by a controller of the battery-powered wireless node.

22. The method according to claim 1, wherein the low power wide area network (LPWAN) network protocol is a long-range wide area network (LoRaWAN) network protocol or a MIOTY network protocol.

23. A wireless node, comprising:
an antenna;
a controller;
a battery;
a sensor and/or an actuator; and
the wireless node is configured to implement the method according to claim 1.
